(19) United States
(12) Patent Application Publication
(10) Pub. No.: US 2014/0281871 A1
(43) Pub. Date: Sep. 18, 2014

(54) METHOD FOR MAPPING FORM FIELDS FROM AN IMAGE CONTAINING TEXT

(71) Applicant: Meditory LLC, Brighton, MI (US)

(72) Inventors: Alexander Brunner, Howell, MI (US); Sidney Trey Smith, Howell, MI (US); Randall Timothy Long, Brighton, MI (US)

(21) Appl. No.: 13/834,940

(22) Filed: Mar. 15, 2013

(51) Int. Cl. G06F 17/24; G06K 9/18

(52) U.S. Cl. CPC G06F 17/243; G06K 9/18
USPC 715/226

(57) ABSTRACT

Provides a number of methods of mapping form fields on a computer-readable image file, as well as a method for automatically redacting some portions of the image file. One method includes the steps of: performing optical character recognition (OCR) on the image file to produce digitized text. The digitized text is compared with a plurality of keywords to identify at least one known form field on the image file. Each keyword is associated with one of the form fields. Then the location on the image file of any known form fields is compared with the locations of those same form fields within any provided template. Each template has at least one form field in a unique location from the other provided templates, and thereby it is possible to identify the template that matches the image file.

### BACKGROUND OF THE INVENTION

1. Field of the Invention

The present invention pertains to a method of mapping form fields from an image containing text. And in particular, the present invention pertains to a method of mapping form fields from a prescription label as well as redacting sensitive patient information from the prescription label.

2. Description of the Prior Art

Medical providers and home health agencies that monitor at-home patients are required to file a 100% accurate drug reconciliation and certification with Medicare upon admission of every new patient, and then a re-certification every 60 days in order for the patient to continue to receive Medicare reimbursements for home healthcare.

Currently, this is accomplished by sending the home care nurse to the patient's location and the nurse must gather all of the patient's pill bottles, boxes, and tubes, as well as all over-the-counter medications and vitamin bottles or boxes. It is also beneficial to collect any other supplements or nutritional additives that the patient may also be taking. For each container, the nurse must record the prescription number, the number of pills, the number of refills remaining, dosage instructions, the prescribing doctor's name and phone number, the pharmacy name and phone number, and so on.

The nurse records this information in the field by either writing all of this information down on paper, or typing it into a computer. In the vast majority of instances, the nurse records this information by hand writing it down because a computer is either not available or the nurse is more familiar and comfortable with writing the information by hand. Regardless of whether the information is written by hand or typed into a laptop computer, there is room for error and it is a time-consuming activity. This intake procedure can easily take from 30 to 60 minutes, depending upon the number of containers.

The applicants have invented a new device and method for quickly and accurately obtaining computer-readable image files of prescription labels, even when the prescription container is irregularly-shaped or the prescription label curves around the surface of the container. This is disclosed in a co-pending application previously-filed by the applicants.

This patent application discloses the second step in the overall process. In other words, this patent application seeks to overcome the shortcomings in the prior art by starting with the image files of the prescription labels provided in the first step, and then processing those image files to map out the various form fields on the prescription label, export the information in digitized form, and also automatically redacting HIPAA-sensitive material when necessary.

The present invention, as is detailed hereinbelow, seeks to improve upon the prior art by quickly and accurately digitizing the text on a prescription label and automatically identifying each form field on the label.

### SUMMARY OF THE INVENTION

The invention, as described hereinbelow, is a method for automatically redacting a textual portion from a computer-readable image file having text including the steps of: (a) providing a computer having a processor; (b) providing the computer-readable image file; (c) performing, by the processor, optical character recognition (OCR) on the image file to produce digitized text; (d) providing text that has been inputted into the computer by a user; (d) searching, by the processor, within the digitized text for a match of the inputted text; (e) locating, by the processor, of the textual portion in the image file that corresponds to the digitized text which matches the inputted text; and (f) redacting, by the processor, the textual portion from the image file.

Optionally, this method can include the step of performing, by the processor, an additional OCR using a different set of OCR filters than the previous OCR when the inputted text cannot be located within the digitized text.

Optionally, this method can include the steps of locating, by the processor, a second textual portion below the textual portion, the second textual portion having substantially the same font size as the textual portion; and redacting a third portion of text that is between the textual portion and the second textual portion. The third portion of text can include the patient's address.

Preferably, but not necessarily, the image file is an image of a prescription label, and the textual portion includes privacy-sensitive material. More specifically, the textual portion can include the name of a patient.

According to another embodiment hereof, there is provided a method of mapping form fields on a computer-readable image file including the steps of: (a) providing a computer having a processor; (b) providing the computer-readable image file; (c) performing, by the processor, optical character recognition (OCR) on the image file to produce digitized text; (d) comparing, by the processor, the digitized text with a plurality of keywords to identify at least one known form field on the image file, each keyword being associated with one of the form fields; and (e) comparing, by the processor, the location on the image file of any known form fields with the locations of those same form fields within any template in a provided plurality of templates, each template having at least one form field in a unique location from the other provided templates, and thereby identifying the template that matches the image file.

Optionally, this method can also include the steps of: inputting a patient's name into the computer; searching for the patient's name within the digitized text; and identifying any template having the patient's name in the same location as the image file.

Optionally, this method can also include the step of first uploading the computer-readable image file to the computer across a computer network, the computer being an Internet-accessible web server.

Just as with the first method described above, the image file can be an image of a prescription label. Furthermore, each template can optionally be a prescription label template used by a unique pharmacy.

In a third embodiment hereof, there is provide a method of mapping form fields on a computer-readable image file including the steps of: (a) providing a computer having a processor; (b) providing the computer-readable image file; (c) entering a patient's information into the computer by a user; (d) performing, by the processor, optical character recognition (OCR) on the image file to produce digitized text; (e) providing a database of keywords, the keywords each being associated with one of the form fields; (f) identifying, by the processor, a name form field on the image file by comparing the entered patient information with the digitized text, and locating on the image file the digitized text that matches the patient information; (g) comparing, by the processor, any digitized text that matches the keywords; and (h) mapping the form fields in the location of the matching digitized text.

Optionally, this method can include the step of first uploading the computer-readable image file to the computer across a computer network, the computer being an Internet-accessible web server.

Optionally, this method can include the step of manually identifying at least one form field that was not identified by comparing the digitized text with the keywords.

As with the embodiments described above, the image file can optionally be an image of a prescription label, and the patient information can optionally be the patient's name.

In a fourth embodiment hereof, there is provided a method of mapping form fields on a computer-readable image file including the steps of: (a) providing a remote computer and a central computer, each computer being network-accessible and having a processor; (b) providing a plurality of computer-readable still images from varying angles about an object; (c) providing the computer-readable image file stored on the remote computer, the image being a composite stitched image of the plurality of still images; (d) uploading the image file and the still images from the remote computer to the central computer; and (e) extracting text from the image file.

Optionally, this method includes the steps of obtaining the still images with a camera that is connected to the remote computer, and stitching the still images together, by the processor on the remote computer, to create the image file.

Optionally, the object may be a prescription drug container, and the image file may be a prescription label.

The text may also be optionally extracted by typing information from the image file into the central computer, or optionally extracted by performing optical character recognition on the image file by the processor in the central computer.

In a fifth embodiment hereof, there is provided a method of mapping form fields on a computer-readable image file including the steps of: (a) providing a remote computer and a central computer, each computer being network-accessible and having a processor; (b) providing the computer-readable image file; (c) providing a name of a patient entered into the remote computer; (d) uploading the image file and the patient name from the remote computer to the central computer across a network; (e) performing, by the central computer processor, optical character recognition (OCR) on the image file to produce digitized text; (f) comparing, by the central computer processor, the digitized text with a plurality of keywords to identify at least one known form field on the image file, each keyword being associated with one of the form fields; and (g) comparing, by the central computer processor, the location on the image file of any known form fields with the locations of those same form fields within any template in a provided plurality of templates, each template having at least one form field in a unique location from the other provided templates, and thereby identifying the template that matches the image file.

As with the embodiments described above, the image file may optionally be an image of a prescription label, and each template may optionally be a prescription label template used by a unique pharmacy.

Optionally, this method can include the steps of: searching for the patient's name within the digitized text by the central computer processor; and identifying, by the central computer processor, any template having the patient's name in the same location as the image file.

In yet a sixth embodiment hereof, there is provided a method of mapping form fields on a computer-readable image file including the steps of: (a) providing a remote computer and a central computer, each computer being network-accessible and having a processor; (b) providing the computer-readable image file; (c) providing a patient information entered into the remote computer; (d) uploading the image file and the patient information from the remote computer to the central computer across a network; (e) performing, by the central computer processor, optical character recognition (OCR) on the image file to produce digitized text; (f) providing a database of keywords stored in the central computer, the keywords each being associated with one of the form fields; (g) identifying, by the central computer processor, a name form field on the image file by comparing the entered patient information with the digitized text, and locating on the image file the digitized text that matches the patient information; (h) comparing, by the central computer processor, any digitized text that matches the keywords; and (i) mapping the form fields in the location of the matching digitized text.

As with the embodiments described above, the image file may optionally be an image of a prescription label, and the patient information may optionally be the patient's name.

Optionally, this method may include the step of manually identifying at least one form field that was not identified by comparing the digitized text with the keywords.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is a flowchart showing a process by which the image file is created so that it is prepared for processing;

FIG. 2 is a flowchart showing an overall process for performing OCR and mapping the form fields and exporting the data contained therein into a suitable format for additional processing;

FIG. 3 is a flowchart showing a method for identifying and redacting the patient's name from the image file;

FIG. 4 is a flowchart showing a method for mapping the form fields in the image file by identifying a matching pharmacy template;

FIG. 5 is a flowchart showing a method for mapping the form fields in the image file by searching the form fields for known keywords to identify the form fields and create a new template;

FIG. 6 is a flowchart showing a method for obtaining an image file with a remote computer, uploading the image file to a central computer, and then mapping the form fields in the image file by identifying a matching pharmacy template by the central computer;

FIG. 7 is a flowchart showing a method for obtaining an image file with a remote computer, uploading the image file to a central computer, and then mapping the form fields in the image file by searching the form fields for known keywords to identify the form fields and create a new template using the central computer; and

FIG. 8 is a flowchart showing a method for uploading the image file and a plurality of still images to a remote computer, and then ample enlarged display of pixels to help depict the method for locating an edge of the container described herein.

### DETAILED DESCRIPTION OF THE PREFERRED EMBODIMENT

The present invention includes an overall process that is shown in FIG. 2. Other drawings provided shown various aspects of this overall process in greater detail or with optional or alternative steps.

In accordance with the present invention and as shown generally in FIG. 3, there is provided a method for automatically redacting a textual portion from a computer-readable image file having text including the steps of: (a) providing a computer having a processor; (b) providing the computer-readable image file; (c) performing, by the processor, optical character recognition (OCR) on the image file to produce digitized text; (d) providing text that has been inputted into the computer by a user; (d) searching, by the processor, within the digitized text for a match of the inputted text; (e) locating, by the processor, of the textual portion in the image file that corresponds to the digitized text which matches the inputted text; and (f) redacting, by the processor, the textual portion from the image file.

The computer is any suitable type of computer having a processor that is well-known in the art. The computer is accessible, or connectable, to a network, such as the Internet. As understood in the art, the processor can run various software programs, and through any number of programs it can perform the various steps described hereinbelow.

There is also referenced below a remote computer and a central computer. The remote computer is one that is used and operated by a caregiver like a nurse in the field. The central computer is any other network-connectable computer, but preferably it is an Internet-connected web server. According to one aspect hereof, there is provided a plurality of remote computers in use by nurses in various locations. There may be one or a more limited number) central computer, and the remote computers upload either processed information (files such as .xml, .xls, .txt, etc.) or image files to the central computer(s) for processing at a centralized location.

In the next step, the computer is provided with a computer-readable image file. The image file is described in detail in the U.S. patent application Ser. No. 13/752,009, the entire disclosure of which is hereby incorporated by reference. A flowchart describing an embodiment of that process is shown in FIG. 1. In summary of that application, a series of still images are obtained of, and around, a container like a prescription bottle. Those still images are stitched together to form a single cohesive and flat image file of the prescription label. As referenced below, this is the stitched image. The image file is essentially a digital photograph of the prescription label, and it can be any suitable type of image file format, such as Jpeg, Bitmap, TIFF, and so on.

Preferably, but not necessarily, the image file is an image of a prescription label, and the textual portion includes privacy-sensitive material. More specifically, the textual portion preferably includes the name of a patient.

Next, the computer processor performs optical character recognition (OCR) on the image file to produce digitized text of the graphical characters in the image. The specific OCR algorithms and settings are beyond the scope of this application, but both those that are well-known in the art and those that are proprietary may be used. It is understood that multiple OCR processes may be performed, and that those various OCR processes may result in stronger confidence readings for some characters, and possibly weaker confidence readings for other characters. Thus, by applying multiple OCR processes (when needed or desired), a stronger confidence reading of the entire image file can be obtained than by any single OCR process alone. In addition, OCR processes are known in the art to extract digitized standard characters from a graphical image so that the characters displayed on the image can be searched, processed, easily copied, and so forth. As referenced herein, “digitized text” is mean to refer to text which is searchable standard characters as known in the art.

The next step includes providing text that has been inputted into the computer by a user. The text can relate to any suitable type information that is located on the image file, or on the prescription label. As described in greater detail below, the text is provided to help locate or identify a “known” form field in the image file. Preferably the text is the patient's name (first and/or last name) and/or address, but it can be the prescription number, the drug name, the prescribing doctor's name, the pharmacy name, etc.

Next, the computer processor searches within the digitized text for a match of the text inputted in the last step. The objective of this step is to find the digitized text that has already been entered. Once this step is completed, the processor then locates, on the textual portion of the image file, the digitized text which matches the inputted text. Thus, at this point the computer processor has located on the graphical image a match of the text that was originally and separately inputted.

The last step according to this method is for the processor to redact the textual portion from the image file. The utility of this method is that a portion of a graphical image can be inputted into the computer and the computer process will then redact that corresponding text from a graphical image. This has significant value in applications where there are privacy concerns. In addition, in order to make certain medical records HIPAA-compliant and suitable for viewing by non-HIPAA-certified personnel, specific information must be redacted. For instance, the patient's name, address, or any other information that can be used to identify the patient.

Optionally, this method can also include the steps of locating a second textual portion below the textual portion, the second textual portion having substantially the same font size as the textual portion; and redacting a third portion of text that is between the textual portion and the second textual portion. In this regard, the third portion of text can include the patient's address. When the image file is a prescription label (as well as any other suitable image files), this method can be used to have the processor redact the patient's address as well.

As described in greater detail below, pharmacies each have their own prescription label format and arrangement of the various form fields. However, the pharmacies are fairly uniform in that they display the patient's name and the drug name in a relatively large font size, and the patient's name is above the drug name. Thus, the second textual portion is preferably the drug's name. In addition, the patient's address is positioned below the patient name and above the drug name, and the patient's address is also printed in a relatively smaller font than that of the patient name and drug name.

Therefore, this step allows the processor redact the patient's address from the image file as well as the patient's name. The resulting redacted image file is then HIPAA-compliant and suitable for transmission over the Internet or viewing by those who are not HIPAA-certified.

The invention uses the patient name as a starting point and assigns the upper left corner of the patient name with x, y coordinates of 0,0. As described in greater detail below, any other form fields in the image can be mapped off of this home location. The exact print location on a prescription label varies from printer to printer and also depending on how the label was loaded into the printer. However, because of the software used to print the labels, the relative locations of the text with respect to other text on a prescription label is consistent. Therefore, an item of information is provided that can be used to consistently identify the patient name on a prescription label, and the upper left hand corner of that text can be assigned an x,y coordinate of 0,0, and the locations of all other text can be located with a coordinate system off of home (that is, 0,0).

According to another embodiment hereof, and as shown in FIG. 4, there is provided a method of mapping form fields on a computer-readable image file including the steps of: (a) providing a computer having a processor; (b) providing the computer-readable image file; (c) performing, by the processor, optical character recognition (OCR) on the image file to produce digitized text; (d) comparing, by the processor, the digitized text with a plurality of keywords to identify at least one known form field on the image file, each keyword being associated with one of the form fields; and (e) comparing, by the processor, the location on the image file of any known form fields with the locations of those same form fields within any template in a provided plurality of templates, each template having at least one form field in a unique location from the other provided templates, and thereby identifying the template that matches the image file.

The objective of this method is to identify the image file as being associated with a particular pharmacy, and then using known information about that pharmacy to map each form field on the image file.

As referenced herein, the form fields are any number of items of information on the image file. When the image file is a prescription label, the form fields can include the patient's name, patient's address, drug name, drug expiration date, pharmacy address, dosage instructions, etc. Any type of information that is provided in a form format can be used, and each of these is referenced throughout as a “form field.”

For purposes of efficiency, the steps of providing the computer, providing the image file, and performing the OCR were describe above and will not be repeated here. The next step is for the computer processor to compare the digitized text with a plurality of keywords to identify at least one known form field on the image file. There is provided a plurality of keywords and each keyword is associated with one of the form fields. For example, the dosage instructions form field could include the keywords: morning, day, evening, night, one, two, three, etc.; the doctor name form field could include: prescriber, MD, or Dr. When a form field says “Dr. Susan Smith,” that form field then becomes a known form field because it contains the keyword “Dr.” and that form field is therefore identified as being the doctor's name. Any other suitable keywords can be determined by one having ordinary skill in the art and associated with the relevant form fields.

Next, the computer processor compares the location on the image file of any known form fields with the locations of those same form fields within any template in a provided plurality of templates. Each template has at least one form field in a unique location from the other provided templates, and therefore each template is wholly unique. When the image file is a prescription label, the templates are the prescription label formats for each pharmacy. Therefore, by searching the form fields for the keywords and identifying the various form fields, the correct template is located and the pharmacy that issued the prescription has been identified.

In another aspect hereof, there may be a variety of databases that can be cross-referenced to verify the information in the form fields. For example, databases containing drug names and dosages, doctor names and addresses, pharmacy names and information, etc. can be used to verify that the OCR information is correct.

Optionally, this method can also include the steps of: inputting a patient's name into the computer; searching for the patient's name within the digitized text; and identifying any template having the patient's name in the same location as the image file. By including this step, a 0,0 home coordinate can be applied which can help with redacting the name, locating other form fields from the home coordinate once those reference coordinates are known, and so forth.

Optionally, this method can also include the step of first uploading the computer-readable image file to the computer across a computer network, the computer being an Internet-accessible web server.

In a third embodiment hereof, and as shown in the flowchart in FIG. 5, there is provide a method of mapping form fields on a computer-readable image file including the steps of: (a) providing a computer having a processor; (b) providing the computer-readable image file; (c) entering a patient's information into the computer by a user; (d) performing, by the processor, optical character recognition (OCR) on the image file to produce digitized text; (e) providing a database of keywords, the keywords each being associated with one of the form fields; (f) identifying, by the processor, a name form field on the image file by comparing the entered patient information with the digitized text, and locating on the image file the digitized text that matches the patient information; (g) comparing, by the processor, any digitized text that matches the keywords; and (h) mapping the form fields in the location of the matching digitized text.

This method includes a variation of the steps that have been described hereinabove. This method is different from the previous method in that this method is intended to use the keywords to map all of the form fields on the entire image file, whereas the last method used the keywords to identify a (pharmacy) template.

Optionally, this method can also include the step of first uploading the computer-readable image file to the computer across a computer network, the computer being an Internet-accessible web server.

When the processor is unable to identify either all, or a threshold number of form fields, this method can optionally can include the step of manually identifying at least one form field that was not identified by comparing the digitized text with the keywords. This manual verification can be used to fill in missing required information. Because this manual verification and entry is performed by a person, it is thus seen that there may be a great need to identify and redact the patient's name and address before the person can view the image file and identify the unknown form fields.

In a fourth embodiment hereof, and as shown in FIG. 8, there is provided a method of mapping form fields on a computer-readable image file including the steps of: (a) providing a remote computer and a central computer, each computer being network-accessible and having a processor; (b) providing a plurality of computer-readable still images from varying angles about an object; (c) providing the computer-readable image file stored on the remote computer, the image being a composite stitched image of the plurality of still images; (d) uploading the image file and the still images from the remote computer to the central computer; and (e) extracting text from the image file.

Optionally, this method includes the steps of obtaining the still images with a camera that is connected to the remote computer, and stitching the still images together, by the processor on the remote computer, to create the image file. This step is described in greater detail in U.S. patent application Ser. No. 13/752,009.

The text may be extracted by manually typing information from the image file into the central computer, or it can be extracted by performing OCR on the image file by the processor in the central computer.

In a fifth embodiment hereof, and as shown in FIG. 6, there is provided a method of mapping form fields on a computer-readable image file including the steps of: (a) providing a remote computer and a central computer, each computer being network-accessible and having a processor; (b) providing the computer-readable image file; (c) providing a name of a patient entered into the remote computer; (d) uploading the image file and the patient name from the remote computer to the central computer across a network; (e) performing, by the central computer processor, optical character recognition (OCR) on the image file to produce digitized text; (f) comparing, by the central computer processor, the digitized text with a plurality of keywords to identify at least one known form field on the image file, each keyword being associated with one of the form fields; and (g) comparing, by the central computer processor, the location on the image file of any known form fields with the locations of those same form fields within any template in a provided plurality of templates, each template having at least one form field in a unique location from the other provided templates, and thereby identifying the template that matches the image file.

This method can also include the steps of: searching for the patient's name within the digitized text by the central computer processor; and identifying, by the central computer processor, any template having the patient's name in the same location as the image file.

In yet a sixth embodiment hereof, and as shown in FIG. 7, there is provided a method of mapping form fields on a computer-readable image file including the steps of: (a) providing a remote computer and a central computer, each computer being network-accessible and having a processor; (b) providing the computer-readable image file; (c) providing a patient information entered into the remote computer; (d) uploading the image file and the patient information from the remote computer to the central computer across a network; (e) performing, by the central computer processor, optical character recognition (OCR) on the image file to produce digitized text; (f) providing a database of keywords stored in the central computer, the keywords each being associated with one of the form fields; (g) identifying, by the central computer processor, a name form field on the image file by comparing the entered patient information with the digitized text, and locating on the image file the digitized text that matches the patient information; (h) comparing, by the central computer processor, any digitized text that matches the keywords; and (i) mapping the form fields in the location of the matching digitized text.

This method can also optionally include the step of manually identifying at least one form field that was not identified by comparing the digitized text with the keywords.

Although the invention has been discussed with respect to the medical field, and more specifically for use with prescription drug labels, methods described herein can be used with any suitable type of images files containing graphical text that needs to be digitized into standard characters, identified, verified, and so forth.

As is apparent from the preceding, the present invention provides a number of methods that quickly and accurately digitize the text on a prescription label and automatically identify each form field on the label.

What is claimed is:

1. A method for automatically redacting a textual portion from a computer-readable image file having text including the steps of:
providing a computer having a processor;
providing the computer-readable image file;
performing, by the processor, optical character recognition (OCR) on the image file to produce digitized text;
providing text that has been inputted into the computer by a user;
searching, by the processor, within the digitized text for a match of the inputted text;
locating, by the processor, of the textual portion in the image file that corresponds to the digitized text which matches the inputted text; and
redacting, by the processor, the textual portion from the image file.

2. The method of claim 1 including the step of performing, by the processor, an additional OCR using a different set of OCR filters than the previous OCR when the inputted text cannot be located within the digitized text.

3. The method of claim 1 including the steps of locating, by the processor, a second textual portion below the textual portion, the second textual portion having substantially the same font size as the textual portion; and redacting a third portion of text that is between the textual portion and the second textual portion.

4. The method of claim 1 wherein the image file is an image of a prescription label.

5. The method of claim 1 wherein the textual portion includes the name of a patient.

6. The method of claim 1 wherein the textual portion includes privacy-sensitive material.

7. The method of claim 3 wherein the third portion of text includes the patient's address.

8. A method of mapping form fields on a computer-readable image file including the steps of:
providing a computer having a processor;
providing the computer-readable image file;
performing, by the processor, optical character recognition (OCR) on the image file to produce digitized text;
comparing, by the processor, the digitized text with a plurality of keywords to identify at least one known form field on the image file, each keyword being associated with one of the form fields; and
comparing, by the processor, the location on the image file of any known form fields with the locations of those same form fields within any template in a provided plurality of templates, each template having at least one form field in a unique location from the other provided templates, and thereby identifying the template that matches the image file.

9. The method of claim 8 wherein the image file is an image of a prescription label.

10. The method of claim 8 wherein each template is a prescription label template used by a unique pharmacy.

11. The method of claim 8 including the steps of: inputting a patient's name into the computer; searching for the patient's name within the digitized text; and identifying any template having the patient's name in the same location as the image file.

12. The method of claim 8 including the step of first uploading the computer-readable image file to the computer across a computer network, and the computer is an Internet-accessible web server.

13. A method of mapping form fields on a computer-readable image file including the steps of:
providing a computer having a processor;
providing the computer-readable image file;
entering a patient's information into the computer by a user;
performing, by the processor, optical character recognition (OCR) on the image file to produce digitized text;
providing a database of keywords, the keywords each being associated with one of the form fields;
identifying, by the processor, a name form field on the image file by comparing the entered patient information with the digitized text, and locating on the image file the digitized text that matches the patient information;
comparing, by the processor, any digitized text that matches the keywords; and
mapping the form fields in the location of the matching digitized text.

14. The method of claim 13 wherein the image file is an image of a prescription label.

15. The method of claim 13 wherein the patient information is the patient's name.

16. The method of claim 13 including the step of first uploading the computer-readable image file to the computer across a computer network, and the computer is an Internet-accessible web server.

17. The method of claim 13 including the step of manually identifying at least one form field that was not identified by comparing the digitized text with the keywords.

18. A method of mapping form fields on a computer-readable image file including the steps of:
providing a remote computer and a central computer, each computer being network-accessible and having a processor;
providing a plurality of computer-readable still images from varying angles about an object;
providing the computer-readable image file stored on the remote computer, the image being a composite stitched image of the plurality of still images;
uploading the image file and the still images from the remote computer to the central computer; and
extracting text from the image file.

19. The method of claim 18 wherein the object is a prescription drug container and the image file is a prescription label.

20. The method of claim 18 including the steps of obtaining the still images with a camera that is connected to the remote computer, and stitching the still images together, by the processor on the remote computer, to create the image file.

21. The method of claim 18 wherein the text is extracted by typing information from the image file into the central computer.

22. The method of claim 18 wherein the text is extracted by performing optical character recognition on the image file by the processor in the central computer.

23. A method of mapping form fields on a computer-readable image file including the steps of:
providing a remote computer and a central computer, each computer being network-accessible and having a processor;
providing the computer-readable image file;
providing a name of a patient entered into the remote computer;
uploading the image file and the patient name from the remote computer to the central computer across a network;
performing, by the central computer processor, optical character recognition (OCR) on the image file to produce digitized text;
comparing, by the central computer processor, the digitized text with a plurality of keywords to identify at least one known form field on the image file, each keyword being associated with one of the form fields; and
comparing, by the central computer processor, the location on the image file of any known form fields with the locations of those same form fields within any template in a provided plurality of templates, each template having at least one form field in a unique location from the other provided templates, and thereby identifying the template that matches the image file.

24. The method of claim 22 wherein the image file is an image of a prescription label.

25. The method of claim 22 wherein each template is a prescription label template used by a unique pharmacy.

26. The method of claim 22 including the steps of: searching for the patient's name within the digitized text by the central computer processor; and identifying, by the central computer processor, any template having the patient's name in the same location as the image file.

27. A method of mapping form fields on a computer-readable image file including the steps of:
providing a remote computer and a central computer, each computer being network-accessible and having a processor;
providing the computer-readable image file;
providing a patient information entered into the remote computer;
uploading the image file and the patient information from the remote computer to the central computer across a network;
performing, by the central computer processor, optical character recognition (OCR) on the image file to produce digitized text;
providing a database of keywords stored in the central computer, the keywords each being associated with one of the form fields;
identifying, by the central computer processor, a name form field on the image file by comparing the entered patient information with the digitized text, and locating on the image file the digitized text that matches the patient information;
comparing, by the central computer processor, any digitized text that matches the keywords; and
mapping the form fields in the location of the matching digitized text.

28. The method of claim 27 wherein the image file is an image of a prescription label.

29. The method of claim 27 wherein the patient information is the patient's name.

30. The method of claim 27 including the step of manually identifying at least one form field that was not identified by comparing the digitized text with the keywords.
